(19) United States
(12) Patent Application Publication
(10) Pub. No.: US 2016/0272818 A1
(43) Pub. Date: Sep. 22, 2016

(54) Metal Complexing Agents as Corrosion Inhibitors

(71) Applicant: PRC-DESOTO INTERNATIONAL, INC, Sylmar, CA (US)

(72) Inventor: Eric L. MORRIS, Murrieta, CA (US)

(21) Appl. No.: 14/777,684

(22) PCT Filed: Mar. 13, 2014
(86) PCT No.: PCT/US2014/025841

§ 371 Date: Sep. 16, 2015

Related U.S. Application Data
(60) Provisional application No. 61/802,615, filed on Mar. 16, 2013.

(51) Int. Cl. C09D 5/08; C23F 11/18; C23C 28/00; C23F 11/08; C23C 22/78; C23C 26/00

(52) U.S. Cl. CPC C09D 5/08; C23C 22/78; C23C 26/00; C23C 28/00; C23F 11/08; C23F 11/185

(57) ABSTRACT

A composition for application to a metal substrate comprises a metal cation, a metal complexing agent and an aqueous carrier. A substrate or article includes the composition for application to a metal substrate and a coating on the composition. A method of fabricating a substrate comprises applying the composition to a substrate, allowing the composition to dry to form a conversion coating, and applying a coating on the conversion coating.

### CROSS-REFERENCE TO RELATED APPLICATION(S)

This application claims priority to and the benefit of U.S. Provisional Application Ser. No. 61/802,615, filed on Mar. 16, 2013 in the U.S. Patent and Trademark Office, the entire content of which is incorporated herein by reference.

### BACKGROUND

The oxidation and degradation of metals used in aerospace, commercial, and private industries are serious and costly problems. To prevent the oxidation and degradation of the metals used in these applications; a protective coating can be applied to the metal surface. This protective coating may be the only coating applied to the metal, or other coatings can be applied to further protect the metal surface. One problem that may be faced by manufacturers when coating a metal surface to prevent corrosion is that other metals on the surface may interfere with conversion coating solutions and prevent adequate deposition of the corrosion inhibiting species contained within the conversion coating onto the metal surface.

Corrosion resistant coatings are known in the art of metal finishing, and older technologies involve chrome based coatings which can be effective at preventing corrosion on a metal surface, but have an undesirable environmental impact. Other corrosion resistant coatings are also known, including some chrome free coatings and/or pre-treatment coatings that may prevent or reduce oxidation and degradation of metals and aid in corrosion resistance.

Several attempts have been made to add a copper and/or iron removing species to a metal deoxidizer or degreaser, as copper and/or iron on the surface has been found to increase a metal's tendency to corrode. However, it has been found that these compositions do not promote later conversion coating deposition. Accordingly, a composition capable of removing copper and/or iron that also promotes later conversion coating deposition would be desirable.

### SUMMARY

A composition for application to a metal substrate comprises a metal complexing agent, a metal cation, and an aqueous carrier.

### DESCRIPTION

According to embodiments of the present invention, a composition for application to a metal substrate comprises an aqueous carrier, a metal complexing agent capable of binding and/or removing one or both of copper and/or iron from a metal surface (e.g., an aluminum or aluminum alloy surface), and a corrosion inhibitor comprising a metal cation. In some embodiments, the metal cation comprises a rare earth species (e.g., Ce (cerium) and/or Y (yttrium) cations), Zr (zirconium), a Group IA metal cation (e.g., Li (lithium)), and/or Zn (zinc). In some embodiments, the metal cation may include Cr (chromium). However, in other embodiments, the composition is substantially chrome-free. As used herein, the term “substantially” is used as a term of approximation and not as a term of degree. Additionally, the term “substantially chrome-free” is used as a term of approximation to denote that the amount of chrome in the composition is negligible, such that if chrome is present in the composition at all, it is as an incidental impurity. According to some embodiments, the metal cation is provided in the composition in the form of a salt, and the salt may comprise yttrium nitrate, cerium nitrate, cerium chloride, zinc fluoride, hexafluorozirconate and/or lithium carbonate.

The metal complexing agent may comprise a compound capable of binding to one or both of copper and/or iron on the surface of metal substrate (e.g., an aluminum alloy substrate). The term “metal complexing agent,” as used herein, refers to a metal chelating compound having two or more coordinating bonds between a polydentate ligand and a single central atom. In some embodiments, the metal complexing agent may comprise an organic compound, and may also be referred to herein as a chelant, chelator, chelating agent, chelating compound, or sequestering agent.

According to embodiments of the present invention, a metal complexing agent may be incorporated into a composition for application to a metal substrate (e.g., a conversion coating solution). As the metal substrate is initially contacted with the composition, the copper and/or iron present on the surface will evolve H₂, thus changing the local pH to an OH rich region. This change in local pH allows more of the corrosion inhibiting species (e.g., a rare earth ion, Zr, Cr or Zn) to be deposited. As the composition and corrosion inhibiting species are deposited on the surface of the metal substrate, the metal complexing agent removes copper and/or iron from the surface of the metal. Without copper and/or iron on the surface of the metal, the metal is less prone to corrosion and the deposited corrosion inhibiting species can be more effective at protecting or passivating the metal surface. Accordingly, the compositions according to embodiments of the present invention comprise a metal complexing agent capable of scavenging metals (e.g., Cu and/or Fe) from the surface of a metal substrate (e.g., an aluminum alloy) to aid in deposition of the composition and corrosion resistance.

As used herein, the following terms have the following meanings.

The term “salt” as used herein, refers to an ionically bonded inorganic compound and/or the ionized anion and cation of one or more inorganic compounds in solution.

The term “substrate,” as used here, refers to a material having a surface. In reference to applying a conversion coating, the term “substrate” refers to a metal substrate such as aluminum, iron, copper, zinc, nickel, magnesium, and/or an alloy of any of these metals including but not limited to steel. Some exemplary substrates include aluminum and aluminum alloys. Additional exemplary substrates include high copper aluminum substrates (i.e., substrates including an alloy containing both aluminum and copper in which the amount of copper in the alloy is high, for example, an amount of copper in the alloy of 3 to 4%).

The term “conversion coating,” also referred to herein as a “conversion treatment” or “pretreatment,” refers to a treatment for a metal substrate that causes the chemistry of the metal surface to be converted to a different surface chemistry. The terms “conversion treatment” and “conversion coating” also refer to the application or treatment of a metal surface in which a metal substrate is contacted with an aqueous solution having a metal of a different element than the metal contained in the substrate. Additionally, the terms “conversion coating” and “conversion treatment” refer to an aqueous solution having a metal element in contact with a metal substrate of a different element, in which the surface of the substrate partially dissolves in the aqueous solution, leading to the precipitation of a coating on the metal substrate (optionally using an external driving force to deposit the coating on the metal substrate).

The term “rare earth element,” as used herein, refers to an element in Group IIIB (or the lanthanide series) of the periodic table of the elements or yttrium. The group of elements known as the rare earth elements includes, for example, elements 57-71 (i.e., La, Ce, Pr, Nd, Pm, Sm, Eu, Gd, Tb, Dy, Ho, Er, Tm, Yb and Lu) and yttrium. In some embodiments, however, as noted below, the term rare earth element may refer to La, Ce, Pr, Nd, Sm, Eu, Gd, Tb, Dy, Ho, Er, Tm, Yb, Lu and Y.

The term “Group IA metal ion,” or “Group 1 metal ion” as used herein, refers to an ion or ions of elements from the first column of the periodic table (with the exception of H). The group of elements identified by Group IA or Group 1 (with the exception of H) is also known as the alkali metals, and includes, for example, Li, Na, K, Rb, Cs, and Fr.

The term “Group IIA metal ion,” or “Group 2 metal ion” as used herein, refers to an ion or ions of elements from the second column of the periodic table. The group of elements identified by Group IIA or Group 2 is also known as the alkali earth metals, and includes, for example, Be, Mg, Ca, Sr, Ba and Ra.

The term “metal complexing agent,” as used herein, refers to a compound capable of coordinating to one or both of copper and/or iron on the surface of a metal substrate (e.g., an aluminum alloy substrate). In some embodiments, the term “metal complexing agent” may refer to a metal chlelating agent having two or more coordinating bonds between a polydentate ligand and a single central atom. In some embodiments, the metal complexing agent may be an organic compound, and may also be referred to herein as a chelant, chelator, chelating agent, chelating compound, or sequestering agent.

As used in this disclosure, the term “comprise” and variations of the term, such as “comprising” and “comprises,” are not intended to exclude other additives, components, integers ingredients or steps.

All amounts disclosed herein are given in weight percent of the total weight of the composition at 25° C. and one atmosphere pressure, unless otherwise indicated.

According to embodiments of the invention, a composition for application to a metal substrate (e.g., an aluminum alloy substrate) comprises a corrosion inhibitor comprising a metal cation, and a metal complexing agent. The metal complexing agent may be capable of binding and/or removing one or both of copper and/or iron from the surface of the metal substrate (e.g., an aluminum or aluminum alloy substrate).

In some embodiments, the metal complexing agent comprises a metal chelating compound which binds, e.g., coordinates, to copper and/or iron species on the surface of a metal substrate (e.g., an aluminum alloy) to remove (or reduce the amount of) copper and/or iron species from the surface of the metal substrate (e.g., an aluminum alloy substrate). Examples of metal complexing agents include compounds that exhibit the ability to dissolve, e.g., solubilize, copper and/or iron. The metal complexing agent may be present in the composition in an amount of 0.005 g/1000 L of composition to 3 g/1000 L of composition, and in some embodiments 0.01 g/1000 L of composition to 0.3 g/1000 L of composition. Nonlimiting examples of suitable classes of compounds useful as metal chelating compounds include azoles, amines, such as ethylenediamine tetraacetic acid (EDTA), methyl amine, ureas, thioureas, other organosulfur compounds such as those with the general structure (R¹R²N)(R³R⁴N)C═S, thioamides of the formula RC(S)NR₂, where the R, R¹, R², R³ and R⁴ groups are each independently a hydrocarbon substituent, such as, for example, an alkyl or substituted alkyl group, etc., proteins, polysaccharides, polynucleic acids, amino acids, such as glutamic acid and histidine, organic polyacids such as malate, glycinate, and citrate, other various organic acids, such as ascorbic acid, and polypeptides such as phytochelatins.

Some nonlimiting examples of suitable chelating compounds include acetylacetone, aerobactin, aminoethylethanolamine, ATMP (aminotris(methylenephosphonic acid)), BAPTA (1,2-bis(o-aminophenoxy)ethane-N,N,N′,N′-tetraacetic acid), BDTH2 (N,N′-bis(2-mercaptoethyl)isophthalamide), benzotriazole, bipyridine, 2,2′-dipyridine, 4,4′-bipyridine, 1,2-bis(dimethylarsino)benzene, 1,2-bis(dimethylphosphino)ethane, 1,2-bis(diphenylphosphino)ethane, catechol (1,2-dihydroxybenzene), Chelex 100 (a styrene-divinylbenzene copolymer containing iminodiacetic acid available from Bio-Rad Laboratories, Inc., Hercules, Calif.), citric acid, corroles, crown ethers, 18-crown-6 (1,4,7,10,13,16-hexaoxacyclooctadecane), cryptands, 2,2,2-cryptand, cyclen (1,4,7,10-tetraazacyclododecane), defarosirox ([4-[(3Z,5E)-3,5-bis(6-oxo-1-cyclohexa-2,4-dienylidene)-1,2,4-triazolidin-1-yl]benzoic acid), deferiprone (3-hydroxy-1,2-dimethylpyridin-4(1H)-one), deferoxamine (N′-{5-[acetyl(hydroxy)amino]pentyl}-N-[5-({4-[(5-aminopentyl)(hydroxy)amino]-4-oxobutanoyl}amino)pentyl]-N-hydroxysuccinamide, also known as N′-[5-(acetyl-hydroxy-amino)pentyl]-N-[5-[3-(5-aminopentl-hydroxy-carbamoyl)propanoylamino]pentyl]-N-hydroxy-butane diamide), dexrazoxane (4-[(2S)-2-(3,5-dioxopiperazin-1-yl)propyl]piperazine-2,6-dione), trans-1,2-diaminocyclohexane, 1,2-diaminopropane, dibenzoylmethane, diethylenetriamine, diglyme, 2,3-dihydroxybenzoic acid, dimercaprol, 2,3-dimercapto-1-propane sulfonic acid, dimercaptosuccinic acid, dimethylglyoxime, DIOP (2,3-O-isopropylidene-2,3-dihydroxy-1,4-bis(diphenylphosphino)butane), diphenylethylenediamine, DOTA (1,4,7,10-tetraazacyclododecane-1,4,7,10-tetraacetic acid), DOTA-TATE (DOTA-(Tyr³)-octreotate), DTPMP (diethylenetriaminepenta(methylene-phosphonic acid), also known as [[(phosphonomethyl)imino]]bis[[2,1-ethanediylnitrilobis(methylene)]]tetrakis-phosphonic acid), EDDHA (ethylenediamine-N,N′-bis(2-hydroxyphenylacetic acid, also known as 2-[2-[[2-hydroxy-1-(2-hydroxyphenyl)-2-oxoethyl]amino]ethylamino]-2-(2-hydroxyphenyl)acetic acid), EDDS (ethylenediamine-N,N′-disuccinic acid), EDTMP (ethylenediamine tetra(methylene phosphonic acid), also known as [bis(phosphonomethyl)amino]methylphosphonic acid), EGTA (ehtylene glycol tetraacetic acid, also known as ethylene glycol-bis(2-aminoethylether)-N,N,N′,N′-tetraacetic acid), 1,2-ethanediol, ethylenediamine, ethylenediaminetetraacetic acid, etidronic acid, ferrichrome (bis[3-[acetyl(oxido)amino]propyl]-2,5,8,11,14,17-hexaoxo-3,6,9,12,15,18-hexazacyclooctadec-1-yl]propyl]-N-oxidoacetamide), fluo-4 (2-{[2-(2-{5-[bis(carboxymethyl)amino]-2-methylphenoxy}ethoxy)-4-(2,7-difluoro-6-hydroxy-3-oxo-3H-xanthen-9-yl)phenyl](carboxymethyl)amino}acetic acid), fura-2 (an aminopolycarboxylic acid), gluconic acid, glyoxal-bis(mesitylimine), hexafluoroacetylacetone, homocitric acid, iminodiacetic acid, indo-1 (2-[4-(bis(carboxymethyl)amino)-3-[2-[2-(bis(carboxymethyl)amino)-5-methylphenoxy]ethoxy]phenyl]-1H-indole-6-carboxylic acid), metal acetylacetonates, metal dithiolene complexes, metallacrowns, nitrilotriacetic acid, Pendetide (N⁶—[N-[2-[[2-[Bis(carboxymethyl)amino]ethyl](carboxymethyl)amino]ethyl]-N-(carboxymethyl)glycyl]-N²—(N-glycyl-L-tyrosyl)-L-lysine), penicillamine ((2S)-2-amino-3-methyl-3-sulfanyl-butanoic acid), pentetic acid (diethylene triamine pentaacetic acid, also known as DTPA, H₅dtpa, and penta(carboxymethyl)diethylenetriamine), phenanthroline, o-phenylenediamine, phanephos ((S)-(+)-4,12-bis(diphenylphosphino)-[2.2]-paracyclophane, also known as (R)-(−)-4,12-Bis(diphenylphosphino)-[2.2]-paracyclophane), phosphonates, phytochelatins, polyamine carboxylic acid, polyaspartic acid, porphin (also known as porphine), porphyrins, 3-pyridylnicotinamide, 4-pyridylnicotinamide, sodium diethyldithiocarbamate, sodium polyaspartate, terpyridine, tetramethylethlenediamine, tetraphenylporphyrin, 1,4,7-triazacyclononane, triethylenetetramine, triphos (organophosphorus ligands such as, for example, bis(diphenylphosphinoethyl)phenylphosphine, 1,1,1-tris(diphenylphosphinomethyl)ethane, bis(diphenylphosphinophenyl)phenylphosphine), trisodium citrate, trans-1,2-diaminocyclohexane, and 1A,7-trithiacyclononane.

Nonlimiting examples of azole compounds sutiable for use as a metal complexing agent include cyclic compounds having 1 nitrogen atoms, such as pyrroles, 2 or more nitrogen atoms, such as pyrazoles, imidazoles, triazoles, tetrazoles and pentazoles, 1 nitrogen atom and 1 oxygen atom, such as oxazoles and isoxazoles, and 1 nitrogen atom and 1 sulfur atom, such as thiazoles and isothiazoles. Nonlimiting examples of suitable azole compounds include 2,5-dimercapto-1,3,4-thiadiazole (CAS: 1072-71-5), 1H-benzotriazole (CAS: 95-14-7), 1H-1,2,3-triazole (CAS: 288-36-8), 2-amino-5-mercapto-1,3,4-thiadiazole (CAS: 2349-67-9), also named 5-amino-1,3,4-thiadiazole-2-thiol, and 2-amino-1,3,4-thiadiazole (CAS: 4005-51-0). In some embodiments, for example, the azole comprises 2,5-dimercapto-1,3,4-thiadiazole.

The metal cation in the corrosion inhibitor may comprise various metal cations which have corrosion inhibiting characteristics. For example, in some embodiments, the metal cation may comprise a rare earth element, such as, for example, La, Ce, Pr, Nd, Pm, Sm, Eu, Gd, Tb, Dy, Ho, Er, Tm, Yb, Lu and/or Y. In some embodiments, the rare earth element comprises La, Ce, Pr, Nd, Sm, Eu, Gd, Tb, Dy, Ho, Er, Tm, Yb, Lu and/or Y. For example, in some embodiments, the rare earth element comprises Ce, Y, Pr and/or Nd. Other suitable metal cations include Group IA or Group IIA metal cations (i.e., the alkali metals and alkali earth metals) or transition metal cations (e.g., Zr and/or Zn). In some embodiments, for example, the metal cation may comprise Ce, Y, Pr, Nd, Zr, Zn, Li, Na, K and/or Mg.

The metal cation can be present in the composition at a concentration of 0.05 g per liter of composition to 25 g per liter of composition. For example, in some embodiments, the metal cation can be present in the composition at a concentration of 0.05 g per liter of composition to 16 g per liter of composition. In some embodiments, for example, the metal cation can be present in the composition at a concentration of 0.1 g per liter of composition to 10 g per liter of composition. For example, in some embodiments, the metal cation can be present in the composition at a concentration of 1 g per liter of composition to 5 g per liter of composition. For example, when the metal cation includes a rare earth cation or a transition metal cation, the rare earth cation or transition metal cation may be present at a concentration of 0.05 g per liter of composition to 25 g per liter of composition, or 0.1 g per liter of composition to 10 g per liter of composition. When the metal cation includes an alkali metal or alkali earth metal cation, the alkali metal or alkali earth metal cation may be present at a concentration of 0.05 g per liter of composition to 16 g per liter of composition, or 1 g per liter of composition to 5 g per liter of composition. As discussed in further detail below, the metal cation may be provided in the composition in the form of a metal salt, in which case, the amounts listed here reflect the amount of the salt in the composition.

As noted above, the metal cation may be provided in the composition in the form of a salt (i.e., a metal salt may serve as the source for the metal cation in the composition) having an anion and the metal cation as the cation of the salt. The anion of the salt may be any suitable anion capable of forming a salt with the rare earth elements, alkali metals, alkali earth metals, and/or transition metals. Nonlimiting examples of anions suitable for forming a salt with alkali metals, alkali earth metals, transition metals and rare earth elements include carbonates, hydroxides, nitrates, halides (e.g., Cl⁻, Br⁻, I⁻ or F⁻), sulfates, phosphates and silicates (e.g., orthosilicates and metasilicates). For example, the metal salt may comprise a carbonate, hydroxide, halide, nitrate, sulfate, phosphate and/or silicate (e.g., orthosilicate or metasilicate) of Li, Na, K, Rb, Cs, Fr, Be, Mg, Ca, Sr, Ba, Ra, Y, La, Ce, Pr, Nd, Pm, Sm, Eu, Gd, Tb, Dy, Ho, Er, Tm, Yb, Lu, Sc, Ti, Zr, Hf, Rf, V, Nb, Ta, Db, Cr, Mo, W, Sg, Mn, Tc, Re, Bh, Fe, Ru, Os, Hs, Co, Rh, Ir, Mt, Ni, Pd, Pt, Ds, Cu, Ag, Au, Rg, Zn, Cd, Hg and/or Cn. In some embodiments for example, the metal salt may comprise a carbonate, hydroxide, halide, nitrate, sulfate, phosphate and/or silicate (e.g., orthosilicate or metasilicate) of Li, Na, K, Rb, Cs, Be, Mg, Ca, Sr, Ba, Y, La, Ce, Pr, Nd, Sm, Eu, Gd, Tb, Dy, Ho, Er, Tm, Yb, Lu, Sc, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd and/or Hg. In some embodiments, for example, the metal salt may comprise a carbonate, hydroxide, halide, nitrate, sulfate, phosphate and/or silicate (e.g., orthosilicate or metasilicate) of Li, Na, K, Rb, Cs, Be, Mg, Ca, Sr, Ba, Y, La, Ce, Pr, Nd, Sm, Eu, Gd, Tb, Dy, Ho, Er, Tm, Yb, Lu, Sc, Ti, Zr, Hf, V, Nb, Ta, Mo, W, Mn, Tc, Re, Ru, Os, Co, Rh, Ir, Pd, Pt, Ag, Au, Zn, Cd and/or Hg. For example, in some embodiments, the metal salt may comprise a carbonate, hydroxide, halide, nitrate, sulfate, phosphate and/or silicate (e.g., orthosilicate or metasilicate) of Ce, Y, Pr, Nd, Zr, Zn, Li, Na, K and/or Mg. Additionally, in some embodiments, the composition may include at least two metal salts, and the at least two metal salts may comprise different anions and/or cations from each other. For example, the at least two metal salts may comprise different anions but the same cations, or may comprise different cations but the same anions.

In some embodiments, the composition may further comprise an oxidizing agent. Any suitable oxidizing agent may be used, nonlimiting examples of which include organic peroxides, such as benzoyl peroxides, ozone and nitrates. One nonlimiting example of a suitable oxidizing agent is hydrogen peroxide. In some embodiments, the oxidizing agent may be present in the composition in an amount of 0.001 wt % to 15 wt %. For example, in some embodiments the oxidizing agent may comprise a 30% solution of hydrogen peroxide present in an amount of 0.001 wt % to 15 wt %, for example 0.002 wt % to 0.006 wt %.

In some embodiments, the composition may be an aqueous coating composition, and the composition may therefore further include an aqueous carrier which may optionally comprise one or more organic solvents. Nonlimiting examples of suitable such solvents include propylene glycol, ethylene glycol, glycerol, low molecular weight alcohols, and the like. When used, the organic solvent may be present in the composition in an amount of 30 g solvent per 12 liters of composition to 6 liters of solvent per 12 liters of composition, with the remainder of the carrier being water. For example, in some embodiments, the organic solvent may be present in the composition in an amount of 100 g solvent per 12 liters of composition to 2 liters of solvent per 12 liters of composition, with the remainder of the carrier being water. In some embodiments, however, the aqueous carrier is primarily water, e.g., deionized water. The aqueous carrier is provided in an amount sufficient to provide the composition with the concentrations of the metal ion(s) and metal complexing agent(s) described above.

In some embodiments of the present invention, composition may further comprise one or more additives for promoting corrosion resistance, adhesion to the metal substrate, adhesion of subsequent coatings, and/or to provide another desired aesthetic or functional effect. An additive, if used, may be present in the composition in an amount of 0.01 weight percent up to 80 weight percent based on the total weight of the composition. These optional additives may be chosen based on the desired function of the resulting coating and/or its application or intended use. Suitable additives may include a solid or liquid component admixed with the composition for the purpose of affecting one or more properties of the composition. The additive may include, for example, a surfactant, which can assist in wetting the metal substrate, and/or other additives that can assist in the development of a particular surface property, such as a rough or smooth surface. Other nonlimiting examples of suitable additives include flow control agents, thixotropic agents such as bentonite clay, gelatins, cellulose, anti-gassing agents, degreasing agents, anti-foaming agents, organic co-solvents, catalysts, dyes, amino acids, urea based compounds, complexing agents, valence stabilizers, and the like, as well as other customary auxiliaries. Suitable additives are known in the art of formulating compositions for surface coatings and can be used in the compositions according to embodiments of the present invention, as would be understood by those of ordinary skill in the art with reference to this disclosure.

In some embodiments, the composition may additionally comprise a surfactant (such as, for example, an anionic, nonionic and/or cationic surfactant), mixture of surfactants, or detergent-type aqueous solution. Nonlimiting examples of some suitable commercially available surfactants include Dynol 604 and Carbowet DC-01 (both available from Air Products & Chemicals, Inc., Allentown, Pa.), and Triton X-100 (available from The Dow Chemical Company, Midland, Mich.). The surfactant, mixture of surfactants, or detergent-type aqueous solution may be present in the composition in an amount of 0.0003 wt % to 3 wt %, for example, 0.000375 wt % to 1 wt %, or 0.02 wt %. In one embodiment, the composition having a surfactant, mixture of surfactants, or detergent-type aqueous solution may be utilized to combine a metal substrate cleaning step and a conversion coating step in one process. In another embodiment, the composition having a surfactant, mixture of surfactants, or detergent-type aqueous solution can additionally contain an oxidizing agent, as previously described herein.

The composition may also contain other components and additives such as, but not limited to, carbonates, surfactants, chelators, thickeners, allantoin, polyvinylpyrrolidone, halides, and/or adhesion promoters. For example, in some embodiments, the composition may further comprise allantoin, polyvinylpyrrolidone, surfactants, and/or other additives and/or co-inhibitors.

In some embodiments, the composition may also contain an indicator compound, so named because they indicate, for example, the presence of a chemical species, such as a metal ion, the pH of a composition, and the like. An “indicator”, “indicator compound”, and like terms as used herein refer to a compound that changes color in response to some external stimulus, parameter, or condition, such as the presence of a metal ion, or in response to a specific pH or range of pHs.

The indicator compound used according to certain embodiments of the present invention can be any indicator known in the art that indicates the presence of a species, a particular pH, and the like. For example, a suitable indicator may be one that changes color after forming a metal ion complex with a particular metal ion. The metal ion indicator is generally a highly conjugated organic compound. A “conjugated compound” as used herein, and as will be understood by those skilled in the art, refers to a compound having two double bonds separated by a single bond, for example two carbon-carbon double bonds with a single carbon-carbon bond between them. Any conjugated compound can be used according to the present invention.

Similarly, the indicator compound can be one in which the color changes upon change of the pH; for example, the compound may be one color at an acidic or neutral pH and change color in an alkaline pH, or vice versa. Such indicators are well known and widely commercially available. An indicator that “changes color when exposed to an alkaline pH” therefore has a first color (or is colorless) when exposed to an acidic or neutral pH and changes to a second color (or goes from colorless to colored) when exposed to an alkaline pH. Similarly, an indicator that “changes color when exposed to an acidic pH” goes from a first color/colorless to a second color/colored when the pH changes from alkaline/neutral to acidic.

Nonlimiting examples of such indicator compounds include methyl orange, xylenol orange, catechol violet, bromophenol blue, green and purple, eriochrome black T, Celestine blue, hematoxylin, calmagite, gallocyanine, and combinations thereof. According to some embodiments, the indicator compound comprises an organic indicator compound that is a metal ion indicator. Nonlimiting examples of indicator compounds include those found in Table 1. Fluorescent indicators, which will emit light in certain conditions, can also be used according to the present invention, although in certain embodiments the use of a fluorescent indicator is specifically excluded. That is, in certain embodiments, conjugated compounds that exhibit fluorescence are specifically excluded. As used herein, “fluorescent indicator” and like terms refers to compounds, molecules, pigments, and/or dyes that will fluoresce or otherwise exhibit color upon exposure to ultraviolet or visible light. To “fluoresce” will be understood as emitting light following absorption of light or other electromagnetic radiation. Examples of such indicators, often referred to as “tags”, include acridine, anthraquinone, coumarin, diphenylmethane, diphenylnaphthlymethane, quinoline, stilbene, triphenylmethane, anthracine and/or molecules containing any of these moieties and/or derivatives of any of these such as rhodamines, phenanthridines, oxazines, fluorones, cyanines and/or acridines.

TABLE 1

| Compound | Structure | CAS Reg. No. |
|---|---|---|
| Catechol Violet Synonyms: Catecholsulfonphthalein; Pyrocatecholsulfonephthalein; Pyrocatechol Violet | 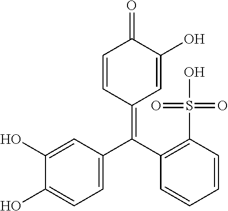 [SMILES: O=C1C=C/C(=C(\c2ccc(O)c(O)c2)c2ccccc2S(=O)(=O)O)C=C1O] | 115-41-3 |
| Xylenol Orange Synonym: 3,3′-Bis[N,N- bis(carboxymethyl)aminomethyl]- o-cresolsulfonephthalein tetrasodium salt | 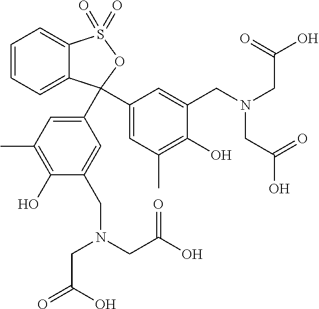 [SMILES: Cc1cc(C2(c3cc(C)c(O)c(CN(CC(=O)O)CC(=O)O)c3)OS(=O)(=O)c3ccccc32)cc(CN(CC(=O)O)CC(=O)O)c1O] | 3618-43-7 |

According to one embodiment, the conjugated compound comprises catechol violet, as shown in Table 1. Catechol violet (CV) is a sulfone phthalein dye made from condensing two moles of pyrocatechol with one mole of o-sulfobenzoic acid anhydride. It has been found that CV has indicator properties and when incorporated into corrosion resistant compositions having metal ions, it forms complexes, making it useful as a chelometric reagent. As the composition containing the CV chelates metal ions, a generally blue to blue-violet color is observed.

According to another embodiment, xylenol orange, as shown in Table 1 is employed in the compositions according to embodiments of the present invention. It has been found that xylenol orange has metal ion indicator properties and when incorporated into corrosion resistant compositions having metal ions, it forms complexes, making it useful as a chelometric reagent. As the composition containing the xylenol orange chelates metal ions, a solution of xylenol orange turns from red to a generally blue color.

The indicator compound may be present in the composition in an amount of from 0.01 g/1000 g solution to 3 g/1000 g solution, such as 0.05 g/1000 g solution to 0.3 g/1000 g solution.

In some embodiments of the present invention, the conjugated compound, if it changes color in response to a certain external stimulus, provides a benefit when using the current compositions, in that it can serve as a visual indication that a substrate has been treated with the composition. For example, a composition comprising an indicator that changes color when exposed to a metal ion that is present in the substrate will change color upon complexing with metal ions in that substrate; this allows the user to see that the substrate has been contacted with the composition. Similar benefits can be realized by depositing an alkaline or acid layer on a substrate and contacting the substrate with a composition of the present invention that changes color when exposed to an alkaline or acidic pH.

In addition, the use of certain conjugated compounds according to the present invention can provide the substrate with improved adhesion to subsequently applied coating layers. This is particularly true if the conjugated compound has hydroxyl functionality. Accordingly, some embodiments of the present compositions allow for deposition of subsequent coating layers onto a substrate treated according to the present invention without the need for a primer layer. Such coating layers can include urethane coatings and epoxy coatings.

In some embodiments, the composition may include metal complexing agent, a rare earth salt and water. The metal complexing agent may be present in this composition in an amount of 0.005 g per 1000 g of composition to 3 g per 1000 g of composition, or 0.01 g per 1000 g of composition to 0.3 g per 1000 g of composition. The rare earth salt may be present in this composition in an amount of 0.05 g per 1000 g of composition to 25 g per 1000 g of composition, or 0.1 g per 1000 g of composition to 10 g per 1000 g of composition. The water may make up the balance of the 1000 g of solution (i.e., the water is provided in an amount sufficient to provide the metal complexing agent and rare earth salt in the concentrations described here).

In some embodiments, the composition may include metal complexing agent, an yttrium salt and water. The metal complexing agent may be present in this composition in an amount of 0.005 g per 1000 g of composition to 3 g per 1000 g of composition, or 0.01 g per 1000 g of composition to 0.3 g per liter of composition. The yttrium salt may be present in this composition in an amount of 0.05 g per 1000 g of composition to 25 g per 1000 g of composition, or 0.1 g per 1000 g of composition to 10 g per 1000 g of composition. The water may make up the balance of the 1000 g of solution (i.e., the water is provided in an amount sufficient to provide the metal complexing agent and yttrium salt in the concentrations described here).

According to some embodiments, the composition may include a metal complexing agent, a transition metal salt (e.g., a salt of Zr, such as a zirconate salt) and water. The metal complexing agent may be present in this composition in an amount of 0.005 g per 1000 g of composition to 3 g per 1000 g of composition, or 0.01 g per 1000 g of composition to 0.3 g per 1000 g of composition. The transition metal salt (e.g., for example a salt of Zr, such as a zirconate salt) may be present in this composition in an amount of 0.05 g per 1000 g of composition to 25 g per 1000 g of composition, or 0.1 g per 1000 g of composition to 10 g per 1000 g of composition. The water may make up the balance of the 1000 g of solution (i.e., the water is provided in an amount sufficient to provide the metal complexing agent and transition metal salt in the concentrations described here).

According to other embodiments, the composition may include a metal complexing agent, a transition metal salt (e.g., a salt of Zn) and water. The metal complexing agent may be present in this composition in an amount of 0.005 g per 1000 g of composition to 3 g per 1000 g of composition, or 0.01 g per 1000 g of composition to 0.3 g per 1000 g of composition. The transition metal salt (e.g., for example a salt of Zn) may be present in this composition in an amount of 0.04 g per 1000 g of composition to 10 g per 1000 g of composition, or 0.8 g per 1000 g of composition to 1 g per 1000 g of composition. The water may make up the balance of the 1000 g of solution (i.e., the water is provided in an amount sufficient to provide the metal complexing agent and transition metal salt in the concentrations described here).

In some embodiments, the composition may comprise a metal complexing agent, a lithium salt and water. The metal complexing agent may be present in this composition in an amount of 0.005 g per 1000 g of composition to 3 g per 1000 g of composition, or 0.01 g per 1000 g of composition to 0.3 g per 1000 g of composition. The lithium salt may be present in this composition in an amount of 0.05 g per 1000 g of composition to 16 g per 1000 g of composition, or 1 g per 1000 g of composition to 5 g per 1000 g of composition. The water may make up the balance of the 1000 g of composition (i.e., the water is provided in an amount sufficient to provide the metal complexing agent and rare earth salt in the concentrations described here).

According to some embodiments, the composition may comprise metal complexing agent and a rare earth element ion. For example, the composition may comprise an aqueous carrier, a metal complexing agent and a rare earth element ion (provided, e.g., as a rare earth element salt which will dissociate in the aqueous carrier into the rare earth element cation and an anion). In some embodiments, for example, the rare earth element salt comprises first and second rare earth element salts, each salt comprising an anion and a cation, the anion of the first and second salts being different, and the cation of the first and second salts being the same or different, where each cation, individually, is a rare earth element. It has been found that rare earth element salts (such as praseodymium, cerium, neodymium, samarium, and terbium salts) that include a mixture of multiple anions (such as a halide and a nitrate, for example), when incorporated into compositions may influence the deposition parameters of the resulting rare earth element composition, including, for example, the resulting morphology and performance. In some embodiments, for example, the composition may comprise a metal complexing agent, a rare earth element cation (such as cerium or both cerium and yttrium), a combination of nitrate and halide anions, and optionally an oxidizing agent (such as, for example H₂O₂). In some embodiments, the composition has a neutral pH. In some embodiments, for example, the composition may include yttrium nitrate (YNO₃), cerium nitrate (CeNO₃), cerium chloride (CeCl₃), hydrogen peroxide (H₂O₂), a metal complexing agent, and an aqueous carrier (such as water). The yttrium nitrate may be included in an amount of 0.06 g/L to 0.3 g/L (e.g., 0.062 g/L to 0.297 g/L), the cerium nitrate may be included in an amount of 0.06 g/L to 0.3 g/L (e.g., 0.056 g/L to 0.267 g/L), the cerium chloride may be included in an amount of 0.006 g/L to 0.03 g/L, one drop of hydrogen peroxide (i.e., 0.0478 g of a 30% solution of hydrogen peroxide) may be used, the metal complexing agent may be included in amount of 0.005 g/L to 3 g/L, and the aqueous carrier (e.g., water) may be added in an amount sufficient to make one liter of solution and/or to provide the yttrium nitrate, cerium nitrate, cerium chloride and metal complexing agent in the concentrations described here. A composition including yttrium nitrate, cerium nitrate, cerium chloride and a metal complexing agent in the concentrations within the above ranges may have a neutral pH.

For example, in some embodiments, the composition may include 0.062 g/L of yttrium nitrate, 0.056 g/L of cerium nitrate, 0.006 g/L of cerium chloride, 0.005 g/L to 3 g/L of the metal complexing agent, 1 drop of hydrogen peroxide (i.e., 0.0478 g of a 30% solution of hydrogen peroxide), and enough water to bring the composition to a total weight of 800 g, or in some embodiments 3800 g. These example compositions may have a neutral to acidic pH.

In another example embodiment, the composition may include 0.297 g/L of yttrium nitrate, 0.267 g/L of cerium nitrate, 0.03 g/L of cerium chloride, 0.005 g/L to 3 g/L of the metal complexing agent, 1 drop of hydrogen peroxide (i.e., 0.0478 g of a 30% solution of hydrogen peroxide), and enough water to bring the composition to a total weight of 800 g, or in some embodiments 3800 g. These example compositions may have a neutral to acidic pH.

According to some embodiments of the invention, the composition may comprise an aqueous carrier, a metal complexing agent, and a transition metal ion (provided, e.g., as a transition metal salt which will dissociate in the aqueous carrier into the transition metal cation and an anion), such as, for example, zirconium (provided, e.g., as a zirconyl nitrate salt and/or a hexafluorozirconate salt). Other salts, for example, metal nitrates, such as, e.g., yttrium nitrate may also be included in the composition. Examples of additives that may be included in this composition include halide sources, surfactants and polyvinylpyrrolidone.

For example in some embodiments, the composition may include hexafluorozirconate, a metal complexing agent, and an aqueous carrier (e.g., water). In some embodiments, the composition may include 0.48 g/L of hexafluorozirconate, 0.005 g/L to 3 g/L of the metal complexing agent, and enough water to bring the composition to a total weight of 800 g. This composition may have a neutral pH.

According to another embodiment, a process for coating a metal substrate comprises optionally degreasing the metal substrate. The metal substrate may then be immersed or spray coated with an alkaline deoxidizer, e.g., a lithium containing alkaline deoxidizer, for 1 to 10 minutes, e.g., for 3 minutes. The metal substrates may then be allowed to dry at ambient temperature. The metal substrate may then be contacted with a composition according an embodiment of the invention comprising a metal complexing agent and a corrosion inhibitor comprising a metal cation, such as a rare earth ion, a transition metal ion (e.g., Zr and/or Zn), an alkali metal ion (e.g., a lithium ion) and/or an alkali earth metal ion. The composition may be applied without rinsing the substrate prior to and or after coating, although a rinse may be performed if desired.

According to another embodiment of the present invention, an article or substrate comprises a substrate, a composition according to an embodiment of the invention on a surface of the substrate, and a primer on the composition. For example, according to some embodiments, a substrate comprises a metal surface having any of the compositions described above on at least a part of the metal surface. For example, in some embodiments, the substrate comprises an aluminum or aluminum alloy surface having the composition on at least a part of the surface. The substrate may then be coated with a primer and/or a topcoat, i.e., the composition according to embodiments of the invention may be applied to the metal substrate, optionally followed by coating with a primer coat, and/or a topcoat.

The compositions according to embodiments of the invention comprising a metal complexing agent and a corrosion inhibitor comprising a metal ion are compatible with conventional chromate based primer coats, such as the primer coat sold under Product Code Deft 44GN072, available from PRC-DeSoto International, Inc., Sylmar, Calif. Alternately, the primer coat can be a chromate-free primer coat, which chromate-free primer coats are known in the art. Other suitable chrome-free primers include those that can pass the military requirement of MIL-PRF-85582 Class N or MIL-PRF-23377 Class N. Other nonlimiting examples of suitable primer coats include those available from PRC-DeSoto International, Inc., Sylmar, Calif., Product Code numbers Deft 02GN083 and Deft 02GN084.

The article or substrate may additionally comprise a topcoat. The term “topcoat” as used herein, refers to a mixture of binder(s), which can be an organic or inorganic based polymer or a blend of polymers, optionally a pigment, optionally a solvent or mixture of solvents, and optionally a curing agent. A topcoat is typically the coating layer in a single or multi-layer coating system whose outer surface is exposed to the atmosphere or environment, and its inner surface is in contact with another coating layer or polymeric substrate. Topcoats useful with embodiments of the present invention include polyurethane based topcoats. However, other topcoats and advanced performance topcoats can be used in the coating system according to embodiments of the present invention as will be understood by those of ordinary skill in the art with reference to this disclosure. Some nonlimiting examples of suitable topcoats include those conforming to MIL-PRF-85285D, such as Product Code numbers Deft 03W127A and Deft 03GY292, available from PRC-DeSoto International, Inc., Sylmar, Calif. Some nonlimiting examples of suitable advanced performance topcoats include Product Code numbers Defthane® ELT™ 99GY001 and 99W009, available from PRC-DeSoto International, Inc., Sylmar, Calif.

In an alternate embodiment of the present invention, a substrate comprises a composition according to an embodiment of the present invention on the substrate, and a self-priming topcoat, or an enhanced self-priming topcoat on the composition. The term “self-priming topcoat”, also referred to as a “direct to substrate” or “direct to metal” coating, refers to a mixture comprising a binder(s), which can be an organic or inorganic based polymer or blend of polymers, optionally a pigment, optionally a solvent or mixture of solvents, and optionally a curing agent. The term “enhanced self-priming topcoat”, also referred to as an “enhanced direct to substrate coating” refers to a mixture comprising functionalized fluorinated binders, such as a fluoroethylene-alkyl vinyl ether in whole or in part with other binder(s), which can include an organic or inorganic based polymer or blend of polymers, optionally a pigment, optionally a solvent or mixture of solvents, and optionally a curing agent. Self-priming topcoats and enhanced self-priming topcoats useful in the coating system according to embodiments of the present invention are known to those of ordinary skill in the art with reference to this disclosure. Nonlimiting examples of self-priming topcoats include those that conform to TT-P-2756A, Product Code numbers Deft 03W169 and 03GY369, available from PRC-DeSoto International, Inc., Sylmar, Calif. Nonlimiting examples of enhanced self-priming topcoats include Defthane® ELT™/ESPT, available from PRC-DeSoto International, Inc., Sylmar, Calif. Another nonlimiting example of a self-priming topcoat is Product Code number Deft 97GY121, available from PRC-DeSoto International, Inc., Sylmar, Calif.

The self-priming topcoat and enhanced self-priming topcoat may be applied directly to the substrate. The self-priming topcoat and enhanced self-priming topcoat can optionally be applied to an organic or inorganic polymeric coating, such as a primer or topcoat. The self-priming topcoat and enhanced self-priming topcoat may be the coating layer in a single or multi-layer coating system where the outer surface of the coating is exposed to the atmosphere or environment, and the inner surface of the coating may be in contact with the substrate or optional polymer coating or primer.

The primers, topcoats, self-priming topcoats, and enhanced self-priming topcoats can be applied to the substrate, in either a wet or “not fully cured” condition that dries or cures over time, that is, solvent evaporates and/or there is a chemical reaction. The coatings can dry or cure either naturally or by accelerated means, for example, an ultraviolet light cured system to form a film or “cured” coating. The coatings can also be applied in a semi or fully cured state, such as an adhesive.

According to still other embodiments, the metal substrate may be pre-treated prior to contacting the metal substrate with the compositions described above. As used herein, the term “pre-treating” refers to the surface modification of the substrate prior to subsequent processing. Such surface modification can include various operations, including, but not limited to cleaning (to remove impurities and/or dirt from the surface), deoxidizing, and/or application of a solution or coating, as is known in the art. Pre-treatment may have one or more benefits, such as the generation of a more uniform starting metal surface, improved adhesion to a subsequent coating on the pre-treated substrate, and/or modification of the starting surface in such a way as to facilitate the deposition of a subsequent conversion coating.

According to some embodiments, the metal substrate may be prepared by first solvent treating the metal substrate prior to contacting the metal substrate with the composition. As used herein, the term “solvent treating” refers to rinsing, wiping, spraying, or immersing the substrate in a solvent that assists in the removal of inks, oils, etc. that may be on the metal surface. Alternately, the metal substrate may be prepared by degreasing the metal substrate using conventional degreasing methods prior to contacting the metal substrate with composition.

The metal substrate may be pre-treated by solvent treating the metal substrate. Then, the metal substrate may be pre-treated by cleaning the metal substrate with an alkaline cleaner prior to application of the conversion coating composition. One example of a suitable pre-cleaner is a basic (alkaline) pretreatment cleaner. The pre-cleaner may also include a corrosion inhibitor, some of which may “seed” the surface of the metal substrate during the cleaning process with the corrosion inhibitor to minimize metal surface attack, and/or facilitate subsequent conversion coating. Other suitable, but nonlimiting, pre-cleaners include degreasers and deoxidizers, such as Turco 4215-NCLT, available from Telford Industries, Kewdale, Western Australia, Arnchern 7/17 deoxidizers, available from Henkel Technologies, Madison Heights, Mich., and phosphoric acid-based deoxidizers, available from PRC-DeSoto International, Inc., Sylmar, Calif.

In some embodiments, the metal substrate may be pre-treated by mechanically deoxidizing the metal prior to applying the composition on the metal substrate. A nonlimiting example of a typical mechanical deoxidizer is uniform roughening of the surface using a Scotch-Brite pad, or similar device.

According to some embodiments, the metal substrate may be pre-treated by solvent wiping the metal prior to applying the composition to the metal substrate. Nonlimiting examples of suitable solvents include methyl ethyl ketone (MEK), methyl propyl ketone (MPK), acetone, and the like.

Additional optional procedures for preparing the metal substrate include the use of a surface brightener, such as an acid pickle or light acid etch, a smut remover, as well as immersion in an alkaline solution.

The metal substrate may be rinsed with either tap water, or distilled/de-ionized water between each of the pretreatment steps, and may be rinsed well with distilled/de-ionized water and/or alcohol after contact with the conversion coating composition. However, according to some embodiments of the present invention, some of the above described pre-treatment procedures and rinses may not be necessary prior to application of the composition.

Once the metal substrate has been appropriately pretreated, if desired, the composition may then be allowed to come in contact with at least a portion of the surface of the metal substrate. The metal substrate may be contacted with the composition using any conventional technique, such as dip immersion, spraying, or spreading using a brush, roller, or the like. With regard to application via spraying, conventional (automatic or manual) spray techniques and equipment used for air spraying may be used. In other embodiments, the composition may be applied using an electrolytic-coating system.

After contacting the metal substrate with the composition, the metal substrate may optionally be air dried. However, the substrate need not be dried, and in some embodiments, drying may be omitted. A rinse is not required, but may be performed if desired.

According to some embodiments, the metal substrate may be first prepared by mechanical abrasion and then wet-wiped to remove smut. The substrate may then optionally be air-dried prior to application. However, the substrate need not be dried, and in some embodiments, drying may be omitted. Next, the composition may be applied to the metal substrate and allowed to dry, for example in the absence of heat greater than room temperature. However, the substrate need not be dried, and in some embodiments, drying may be omitted. Additionally, the substrate need not be rinsed, and the metal substrate may then be further coated with primers and/or top coats to achieve a substrate with a finished coating.

Whereas particular embodiments of the present disclosure have been described above for purposes of illustration, it will be understood by those of ordinary skill in the art that numerous variations of the details of the present disclosure may be made without departing from the invention as defined in the appended claims, and equivalents thereof. For example, although embodiments herein have been described in connection with “a” metal complexing agent, and the like, one or more of these components or any of the other components recited can be used according to the present disclosure.

Although various embodiments of the present disclosure have been described in terms of “comprising” or “including,” embodiments “consisting essentially of” or “consisting of” are also within the scope of the present disclosure. For example, while the present disclosure describes a composition including a metal ion and metal complexing agent, a composition and/or a solution consisting essentially of or consisting of the metal ion and the metal complexing agent is also within the scope of the present disclosure. Similarly, although a corrosion inhibitor comprising or including a metal ion is described, corrosion inhibitors consisting essentially of or consisting of a metal ion are also within the scope of the disclosure. Thus, as described above, the composition may consist essentially of the metal ion and the metal complexing agent. In this context, “consisting essentially of” means that any additional components in the composition will not materially affect the corrosion resistance of a metal substrate including the composition. For example, a composition consisting essentially of a rare earth ion and a metal complexing agent is free from Group IA metal ions (or Group 1, i.e., the alkali metals), Group IIA metal ions (or Group 2, i.e., the alkali earth metals), and transition metal ions. Also, a composition consisting essentially of an alkali metal ion, an alkali earth metal ion, and/or a transition metal ion and a metal complexing agent is free from rare earth element ions.

As used herein, unless otherwise expressly specified, all numbers such as those expressing values, ranges, amounts or percentages may be read as if prefaced by the word “about,” even if the term does not expressly appear. Further, use of the word “about” reflects the penumbra of variation associated with measurement, significant figures, and interchangeability, all as understood by a person having ordinary skill in the art to which this disclosure pertains. Any numerical range recited herein is intended to include all sub-ranges subsumed therein. Plural encompasses singular and vice versa. For example, while the present disclosure describes “a” metal complexing agent, a mixture of such metal complexing agents can be used. When ranges are given, any endpoints of those ranges and/or numbers within those ranges can be combined within the scope of the present disclosure. The terms “including” and like terms mean “including but not limited to.” Similarly, as used herein, the terms “on,” “applied on,” and “formed on” mean on, applied on, or formed on, but not necessarily in contact with the surface. For example, a coating layer “formed on” a substrate does not preclude the presence of one or more other coating layers of the same or different composition located between the formed coating layer and the substrate.

Notwithstanding that the numerical ranges and parameters set forth herein may be approximations, numerical values set forth in the specific examples are reported as precisely as is practical. Any numerical value, however, inherently contains certain errors necessarily resulting from the standard variation found in their respective testing measurements. The word “comprising” and variations thereof as used in this description and in the claims do not limit the disclosure to exclude any variants or additions.

What is claimed is:

1. A composition for application to a metal substrate, the composition comprising:
a metal complexing agent;
a metal cation; and
an aqueous carrier.

2. The composition according to claim 1, wherein the metal cation comprises a rare earth element cation, an alkali metal cation, an alkali earth metal cation, and/or a transition metal cation.

3. The composition according to claim 1, wherein the composition further comprises an anion capable of forming a salt with the metal cation.

4. The composition according to claim 3, wherein the anion comprises a carbonate ion, a silicate ion, a nitrate ion, a halide ion, a phosphate ion, a sulfate ion, and/or a hydroxide ion.

5. The composition according to claim 1, wherein the metal cation comprises Ce, Y, Pr, Nd, Li, Na, K, Cr, Mg, Zr and/or Zn.

6. The composition according to claim 1, wherein the metal complexing agent comprises a compound capable of binding and/or removing copper and/or iron from a metal surface.

7. The composition according to claim 1, wherein the metal complexing agent comprises an azole, an amine, an organosulfur compound, a protein, a polysaccharide, a polynucleic acid, an amino acid, an organic polyacid, an organic acid and/or a polypeptide.

8. The composition according to claim 1, wherein the metal complexing agent comprises ethylenediamine tetraacetic acid (EDTA), methyl amine, a urea, a thiourea, an organosulfur compound represented by (R¹R²N)(R³R⁴N)C═S where R¹, R², R³ and R⁴ each independently comprise a hydrocarbon substituent, a thioamide represented by RC(S)NR₂ where R comprises a hydrocarbon substituent, glutamic acid, histidine, malate, glycinate, citrate, ascorbic acid, and/or a phytochelatin.

9. An article, comprising:
a substrate; and
the composition of claim 1 on at least a portion of the substrate.

10. The article of claim 9, wherein the substrate comprises aluminum.

11. The article of claim 9, further comprising a coating on at least a portion of the composition.

12. The article of claim 11, wherein the coating comprises a primer coat and/or a topcoat.

13. A method of manufacturing a coated article, the method comprising:
applying the composition of claim 1 to at least a portion of a substrate; and
allowing the composition to dry to form a conversion coating.

14. The method of claim 13, further comprising pre-treating the substrate prior to application of the composition.

15. The method of claim 13, further comprising applying a coating on at least a portion of the conversion coating.

16. The method of claim 15, wherein the coating comprises a primer coat and/or a topcoat.

17. The method of claim 13, further comprising allowing the composition to dry.
